(19) United States
(12) Patent Application Publication
(10) Pub. No.: US 2007/0087111 A1
(43) Pub. Date: Apr. 19, 2007

(54) Meat treatment systems and methods

(75) Inventor: Rudy Steiner, Wichita, KS (US)

Correspondence Address: CARGILL, INCORPORATED, LAW/24, 15407 MCGINTY ROAD WEST, WAYZATA, MN, 55391, US

(73) Assignee: Cargill, Inc., Wayzata, MN (US)

(21) Appl. No.: 11/253,194

(22) Filed: Oct. 18, 2005

(51) Int. Cl. A23L 1/31

(52) U.S. Cl. 426/645

(57) ABSTRACT

The present invention relates to the use of carbon monoxide as a process aid to reduce the curing time of ground beef. Ground beef must presently go through a curing stage of 24 hours to 8 days for the oxymyoglobin to transform to deoxymyoglobin, which presents a desirable purple color for the raw meat. In the present invention the curing process is interrupted when some of the ground beef is not completely cured, i.e., still in the metmyoglobin stage, and the ground beef is packaged in a treatment gas containing carbon monoxide. The carbon monoxide converts the myoglobin into carboxymyoglobin, which has a desirable bright-red cherry color.

### FIELD OF THE INVENTION

The present invention relates to meat processing. More particularly, the present invention relates to treating partially cured meat with carbon monoxide and even more particularly, to a method for utilizing carbon monoxide for reducing the curing time of bulk ground meat.

### BACKGROUND OF THE INVENTION

A factor in the color of many meat products is myoglobin. Myoglobin is a protein that helps to transport oxygen throughout the muscle cell to produce energy, similar to hemoglobin, which transports oxygen through the blood stream. The quantity and the type of myoglobin in the meat helps to determine the color of the meat. The initial myoglobin quantity varies by animal age as well as physical activity of the muscle. The three major forms of myoglobin in ground beef are oxymyoglobin (myoglobin bound to oxygen, MbFe(II)O₂), deoxymyoglobin (myoglobin bound to water) and metmyoglobin (myoglobin bound to nothing, MbFe(III)). It is also known that exposure of myoglobin to carbon monoxide forms carboxymyoglobin, MbFe(II)Co.

Fresh ground beef is normally associated with a red color. The red color is due to the myoglobin being predominantly in the form of oxymyoglobin. When ground beef ages the color changes to brown/tan/green due to enzymatic activity and/or oxidation processes, turning the oxymyoglobin to metmyoglobin. Beef and other meat products may also turn a brownish color when cooked because of the oxidation and denaturation of the oxymyoglobin by heat. The brown/tan/green color resulting from the metmyoglobin is not associated with fresh or desirable ground beef by the consumer. Metmyoglobin, however, is the most stable natural state. Carboxymyoglobin exhibits a bright cherry-red color that is pleasing to the consumer. In addition, carboxymyoglobin is more stable than metmyoglobin.

Metmyoglobin can be converted into deoxymyoglobin through the enzymatic activity that takes place after the enzymes in the meat have used all of the available free oxygen. Deoxymyoglobin gives the meat a purple color. The purple color is associated with fresh ground beef because, when exposed to additional oxygen, the deoxymyoglobin will again absorb oxygen to form oxymyoglobin and the desired cherry red color. When ground beef is vacuum packaged it has more of a purplish color due to the myoglobin being predominantly present as deoxymyoglobin. Over time the ability of the myoglobin to absorb oxygen or water is reduced and the myoglobin remains predominantly in the metmyoglobin state.

When ground beef is first formed by mincing, grinding, cutting or chopping whole muscle, cell walls are broken down and air is introduced into the meat. After the initial grinding in a bulk test and hold program, ground beef is normally held for a period of one to eight or more days so that it may go through a curing process. In some cases the ground beef is held during the curing process in a bulk container called a combo. Pathogen testing is conducted during the curing time from a sample taken before sealing the combos. After the initial grinding in other meat production programs, the ground beef may be immediately packaged in a chub or other packages. In such a program the meat cures in the chub. In such instances the pathogen testing may be done on the whole piece trimmings or on the ground beef product itself, but the meat product is already packaged and may be on the way to the consumer.

During curing, the ground beef goes from a bright cherry-red to a purple color, evidencing the formation of deoxymyoglobin. The enzymes in the ground beef first consume the remaining oxygen in the curing container and form metmyoglobin and then reduce the metmyoglobin to form deoxymyoglobin. This process is referred to as the enzymatic reduction of myoglobin. The ground beef must therefore be allowed to cure long enough for the ground beef to pass through the metmyoglobin stage and then into the deoxymyoglobin stage. Once the ground beef reaches the desired color, the ground beef can be removed from the combo, packaged, and then shipped. When the meat in the deoxymyoglobin stage is opened the meat will re-bloom due to the formation of the oxymyoglobin stage.

Holding the ground beef product in the combo containers requires extended storage space and also requires that the producer of the ground beef hold onto a large inventory of ground beef product at any one time. Curing can take from 1-8 days or longer. Storing and holding the beef in this manner also contributes to difficulties meeting short term increases in demand. There is therefore a need in the art for a method of decreasing the holding and curing time of meat in bulk containers, which would provide greater flexibility to plant operations, inventory management and improved product performance.

### BRIEF SUMMARY OF THE INVENTION

One embodiment of the present invention includes a method of producing a raw meat product with a pleasing color including obtaining a raw meat product containing myoglobin whereby the myoglobin Is predominantly in the oxymyoglobin form, curing the raw meat product for a period of time necessary to convert the myoglobin into metmyoglobin and deoxymyoglobin, and exposing the raw meat product containing the metmyoglobin and deoxymyoglobin to a treatment gas containing carbon monoxide whereby the carbon monoxide reacts with the metmyoglobin and deoxymyoglobin to form carboxymyoglobin.

Another embodiment of the present invention includes a method of reducing the processing time of ground beef during a bulk test and hold program including placing ground beef containing myoglobin in the form of oxymyoglobin into a first gas impermeable container for curing, interrupting the curing of the ground beef after a time that is less than the time required to convert all of the oxymyoglobin into deoxymyoglobin, and exposing the ground beef to a treatment gas comprising carbon monoxide.

Another embodiment of the method for processing a meat product that includes metmyoglobin and deoxymyoglobin includes exposing the meat product to a treatment gas containing carbon monoxide wherein the metmyoglobin and deoxymyoglobin are converted to carboxymyoglobin.

While multiple embodiments are disclosed, still other embodiments of the present invention will become apparent to those skilled in the art from the following detailed description, which shows and describes illustrative embodiments of the invention. The present invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flow chart showing one embodiment of the present invention method.

### DETAILED DESCRIPTION

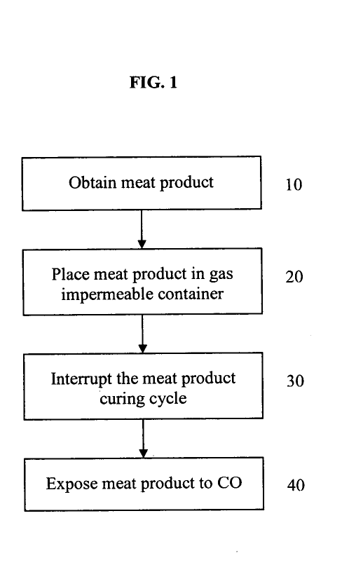

As illustrated in FIG. 1, one embodiment of the present invention is a method of reducing or eliminating the curing time of bulk meat (for example, ground beef) by exposing the bulk ground beef to carbon monoxide (CO) before completion of an entire curing cycle, i.e., conversion of the oxymyoglobin to deoxymyoglobin. The curing cycle in the present description references aging meat in a container without the addition of salt or other materials, but, in further embodiments, the phrase curing can incorporate any curing process that is compatible with the present invention.

In the present embodiment, the first step is obtaining the ground beef (10). The ground beef may be a finely or coarsely ground beef product that is to be packaged in consumer packaging or packaged for sale to a retailer. The source of the ground beef can be from steer, heifer, or more mature carcasses. The ground beef may be ground in a desired manner and may include ground chuck or ground sirloin. In further embodiments the ground beef product may include finely textured beef. In still further embodiments the meat may be in other forms including, but not limited to, carcasses, quarters, retail cuts, and pellets. While the present invention is described in terms of ground beef, the method may also be applicable to other meat products, including, for example, other beef products, pork, lamb, poultry (e.g., chicken, turkey, etc.), and fish.

The ground beef is then placed into a gas impermeable container (20). The gas impermeable container may be a combo or other storage container that is utilized during, for example, a bulk test and hold program. The ground beef is retained in the container for a period of time such that the curing cycle starts, i.e., the conversion of oxymyoglobin to deoxymyoglobin. If new oxygen were to flow to the ground beef this would not occur. In alternative embodiments, the container in which the ground beef is cured can be any gas impermeable container. In still further embodiments the container may be flushed with a gas, such as carbon dioxide, that-does not contain free oxygen. Reducing the amount of oxygen sealed into the container with the ground beef will hasten the curing cycle.

In the present embodiment, before completion of the curing cycle the gas impermeable container is opened and the curing cycle is interrupted (30). Interrupting the curing cycle results in ground beef that includes myoglobin in both the metmyoglobin state and the deoxymyoglobin state. If this material were to be packaged in a normal oxygen atmosphere the metmyoglobin would remain, causing the ground beef to contain brown/tan/green sections. Instead, the ground beef is exposed to CO (40). In the present embodiment the ground beef is packaged in a lidstock container with a treatment gas containing 0.4% CO. The remainder of the treatment gas may be a mix of carbon dioxide, argon, nitrogen, or other selected gases.

Alternative embodiments may use a gas containing about 0.01% or more carbon monoxide. Further embodiments may contain up to about 0.1% CO. Still further embodiments may contain about 0.01% to about 0.05% CO. Further embodiments may contain about 0.05-0.1% carbon monoxide, 0.1-0.5% CO, up to and about 0.4% CO, or greater than about 0.5% CO. Still further embodiments may include approximately 1-100%.CO in the treatment gas. In still further embodiments nitric oxide can be utilized in addition to or as an alternative to CO with similar results.

In the present embodiment the ground beef and the treatment gas may be in an approximately 1:1 ratio (by volume). It has been found that the CO provided by this ratio of 0.4% CO treatment gas provides enough CO to insure conversion to carboxymyoglobin. In further embodiments the volume of treatment gas to volume of meat product may change depending on the concentration of CO, the pressure of the gas, the type of meat, the age of the meat, and other factors.

Since myoglobin has a high affinity for CO, packaging the ground beef with the treatment gas causes the myoglobin, in whichever state, to be converted to carboxymyoglobin. This process may take place during storage and/or shipment of the packaged ground beef. All of the myoglobin, including the myoglobin in the metmyoglobin form, will bond with CO to produce a ground beef with a pleasing color. In this manner the time normally spent curing the ground beef in a bulk hold and test program can be reduced.

The pressure of the treatment gas in the selected container can be normal or elevated. When the pressure is elevated the meat is exposed to a greater amount of CO without increasing the volume percentage of CO in the treatment gas. Introducing the CO at an elevated atmospheric pressure can therefore accelerate or improve the absorption of the CO by the myoglobin. The nature of the container may also affect the pressure to which the ground beef can be packaged with the treatment gas. The CO utilized herein is a food grade bulk CO that is provided in tanks but can be provided in any manner without changing the nature and scope of the present invention.

In addition, the present invention may be utilized during packaging ground beef in bulk chubs, consumer sized chubs, lidstock, or other types of packaging intended for commercial suppliers or consumers. Moreover, the ground beef is not limited to being exposed to the treatment gas containing the CO in the packaging stage. The combo containers in which the ground beef is normally cured can instead be flushed and filled with the treatment gas after interrupting the curing cycle to start the conversion of myoglobin to carboxymyoglobin. Without further assistance the CO may only penetrate about 11 inches into the ground beef. Therefore, in certain embodiments, penetration needles or other devices may be used to inject the treatment gas in order to achieve complete or substantially complete gas penetration in each combo. The ground beef may be exposed to some small amount of air in the packaging process or and/or may be exposed to the treatment gas in the retail package until it reaches the consumer.

In alternative embodiments the beef may be exposed to CO by addition of the treatment gas to the grinder during the grinding process. In one embodiment the grinder or grinder head may be contained in a chamber that is substantially sealed so as to expose the meat to the treatment gas during grinding. The treatment gas may be introduced by hoses, pumps, nozzles or other flow control devices. Moreover, a conveyor with the ground beef may pass through an appropriate seal or other mechanism to reduce or stop the escape of the CO gas into the facility. In another embodiment the treatment gas with the CO may be passed over the ground beef as it passes through the grinder. In such a case the treatment gas can be collected utilizing a hood, vacuum, fans, pipes or other gas collection devices. The treatment gas flow rate and mixture may be controlled by a computer and monitored by gas flow equipment using equipment known to those in the art.

In the present invention the ground beef or other meat product may be stored before and after exposure to the treatment gas between about 30 and about 40° F. In further embodiments the ground beef or other meat product may be stored between about 36 and about 40° F. The selected temperature may be good for preserving the freshness of the meat and may also be at a good temperature to optimize the activity of the enzymes and myoglobin in relation to the preservation of the meat. Colder temperatures may be utilized but may slow the binding of the CO to the myoglobin. The temperature and quality of the myoglobin may also affect the rate at which the myoglobin (whether metmyoglobin or deoxymyoglobin) is changed to carboxymyoglobin by the CO. Other meat products may be held at different temperatures for purposes of storage and during or after exposure to the treatment gas.

Waste treatment gas containing CO may be vented out of the production facility and into the atmosphere. In other embodiments various filters, burners, or other treatment processes or cleaning steps may be utilized on the waste treatment gas to reduce emissions.

The below example illustrates one example of the present invention method of reducing the curing time for producing cured ground beef.

### EXAMPLE

Two fresh 80 pound boxes of ground beef (81/19 coarse grind, 5/8 or 3/8 inch) were sourced from a manufacturing facility (Cargill, Dodge City, Nebr.). The ground beef in the boxes was in the form of 10 pound chubs and was from fed cattle. The boxes were stored under refrigerated conditions at temperatures between 30 and 34° F. until the ground beef product reached 12 days of age to reduce the myoglobin to the deoxymyoglobin state.

Ten chubs weighing ten pounds each were randomly selected from the two boxes. Visual inspection of the chubs was conducted to confirm that the product had been completely reduced to the deoxymyoglobin state during the aging period. Upon observing that the chubs were purple in color it was determined that the ground beef had been properly cured. The chubs were then split open into plastic bins and broken apart so that the ground beef could be completely oxygenated and the myoglobin could form oxymyoglobin. The ground beef chubs were then allowed to bloom for 30 minutes in the plastic bins. During the blooming period the ground beef changed to a bright cherry color that indicated the formation of the oxymyoglobin.

The ground beef was bloomed to replicate the condition of the ground beef just after grinding in the bulk test and hold process. When the product had reached a complete bloom, the ground beef product (totaling 100 lbs.) was placed in an oxygen impermeable plastic bag, in this embodiment, a CVP barrier liner (Downer's Grove Ill.). The plastic bag was back flushed with 100% carbon dioxide and sealed using a CVP Model A300. Back flushing and sealing the impermeable plastic bag simulates flushing and sealing of the bulk combos after grinding. Though the ground beef utilized in this test had already been through the curing process, the curing steps can be replicated several times as long as the enzymes in the ground beef remain active.

Following the placement in the CVP barrier liner, the ground beef product was allowed to begin the enzymatic reduction of the myoglobin, i.e., the ground beef product was allowed to start the curing process. The curing process was purposely interrupted at 24 hours post packaging by opening the CVP barrier liner and exposing the beef to the oxygen in the atmosphere, interrupting the curing process. The interruption of the curing process resulted in ground beef with myoglobin in both the metmyoglobin state (brownish-green) and deoxymyoglobin (purplish-red) state. Oxymyoglobin would not be present, or only present in trace amounts, due to the enzymatic activity while sealed in the CVP barrier liner. The ground beef was observed to have some purple coloring and some brownish-green coloring, confirming the interruption of the curing process.

After observing that the ground beef was indeed in the middle of the curing process, the ground beef product was ground through a ⅛ inch plate. The ground beef was ground again to replicate the bulk test and hold process because in embodiment of this process the already ground beef is ground again into a smaller grind and thereafter directly packaged for the end consumer. In alternative processing routes, the ground beef sold to grocery stores may be of the coarser grind and so the bulk ground beef may not be ground again. The coarser ground beef, however, would be affected by the present invention method in a similar manner. In still further embodiments the ground beef may be ground again and then directly packaged into chub form. In the present embodiment, the forty pounds of the ground beef was then portioned into 1 lb. loaves and placed into standard plastic case-ready display trays (lidstock, 1.91″ deep).

During packaging into the display trays the ground beef was gas flushed with a treatment gas containing 0.4% CO by volume. The treatment gas was sealed in with the ground beef using a ROSS Junior (Ross Reiser, Midland, VA) lidstock machine at normal atmospheric pressure. Thereafter the trays were boxed and stored under refrigerated conditions at temperatures between 30 to 34° F.

After 24 hours of storage the trays were removed and placed in a retail display case for visual inspection of the ground beef product. The ground beef product was visually inspected for the state of the myoglobin, with the primary intention being to determine how much metmyoglobin (brownish-green) and carboxymyoglobin (bright cherry-red) was present. It was observed that the ground beef in the display trays were bright cherry-red in color. All 40 trays were converted to a bright cherry-red carboxymyoglobin state, which is pleasing to the consumer, during the 24 hour storage time. It was determined that during the storage time the myoglobin and the free CO present in the package's atmosphere reacted to form carboxymyoglobin in enough quantity to produce ground beef with a pleasing color. Oxymyoglobin is not formed because the treatment gas does not contain free oxygen.

It is therefore possible to reduce the normal curing time of fresh ground beef. The disclosed method produces a ground beef with a pleasing color at a quicker pace when compared to normal bulk test and hold operations. The curing time of the ground beef can be interrupted while some of the myoglobin protein is still in the metmyoglobin state. Packaging with CO reduces or eliminates the metmyoglobin and therefore reduces or eliminates the metmyoglobin's effect on the ground beef's cooler. The present invention may therefore result in fresher ground beef due to the reduced curing time. In alternative embodiments the ground beef may be exposed to the treatment gas for shorter or longer periods of time depending on the packaging, the time it takes for the ground beef product to reach the consumer, and how long the ground beef must be exposed in the combo to insure the desired exposure. Moreover, the present invention method is not limited to use with a bulk test and hold cycle, but can be used to reduce

The ground beef obtained from the manufacturing facility had already been through the complete bulk test and hold cycle. Ground beef, however, can repeat this process several times with little adverse effect. Therefore the above test does simulate how the ground beef would be affected during the bulk test and hold cycle. In fact, it is expected that the present invention would have even greater efficacy as the enzymes would most likely have greater activity. The amount of ground beef in the metmyoglobin stage when the curing process is interrupted can be up to or greater than 1%, 5%, 10%, 25%, 50%, 75% or up to 100% of the ground beef being packaged. The amount of metmyoglobin may be affected by the cut, age, type of cow, etc.

The raw material used for the test was from fed cattle instead of cows. Fed cattle are fed in confinement with high energy diets of corn, silage, and soybeans. Fed cattle are usually young animals, less than 30 months old. Other cattle may be older and more mature cows, ranging in age up to or more than 8-12 years old. Because beef contains more myoglobin with age, the beef will be more dark red than bright cherry-red. Therefore, processing and curing of ground beef from older cow stock may be impacted more by the present invention method than processing of younger cow stock.

Various modifications and additions can be made to the exemplary embodiments discussed without departing from the scope of the present invention. Accordingly, the scope of the present invention is intended to embrace all such alternatives, modifications, and variations as fall within the scope of the claims, together with all equivalents thereof.

1. A method of producing a raw meat product with a pleasing color comprising:
obtaining a raw meat product containing myoglobin whereby the myoglobin is predominantly in the oxymyoglobin form;
curing the raw meat product for a period of time necessary to convert the myoglobin into metmyoglobin and deoxymyoglobin; and
exposing the raw meat product containing the metmyoglobin and deoxymyoglobin to a treatment gas containing carbon monoxide whereby the carbon monoxide reacts with the metmyoglobin and deoxymyoglobin to form carboxymyoglobin.

2. The method of claim 1 further comprising obtaining raw meat product from one or more of beef, lamb, pork, poultry, and fish.

3. The method of claim 1 wherein the treatment gas contains about 0.4% carbon monoxide by volume.

4. The method of claim 4 wherein the exposing the raw meat product includes exposing a volume of the raw meat to a volume of the treatment gas in approximately a 1:1 ratio.

5. The method of claim 1 wherein exposing the raw meat product to the treatment gas includes exposing the raw meat product to treatment gas that contains about 1.0% carbon monoxide by volume.

6. The method of claim 1 wherein exposing the raw meat to carbon monoxide further comprises exposing the meat trimmings to carbon monoxide at a pressure higher than one atmosphere.

7. The method of claim 1 wherein curing the raw meat further comprises curing the raw meat product for a period of time necessary to convert substantially all of the myoglobin to metmyoglobin.

8. A method of reducing the processing time of ground beef during a bulk test and hold program comprising:
placing ground beef containing myoglobin in the form of oxymyoglobin into a first gas impermeable container for curing;
interrupting the curing of the ground beef after a time that is less than the time required to convert all of the oxymyoglobin into deoxymyoglobin; and
exposing the ground beef to a treatment gas comprising carbon monoxide.

9. The method of claim 8 wherein placing the ground beef into a first gas impermeable container includes placing the ground beef into a combo.

10. The method of claim 8 further comprising packaging the ground beef into a second gas impermeable container after interrupting the curing and before exposing the ground beef to the treatment gas.

11. The method of claim 8 wherein placing the ground beef in the first gas impermeable container includes flushing the container containing the ground beef with carbon dioxide to substantially remove any oxygen from the first gas impermeable container.

12. The method of claim 8 wherein exposing the ground beef to the treatment gas further comprises exposing the ground beef to the treatment gas for a desired period of time.

13. The method of claim 8 wherein exposing the ground beef to the treatment gas further comprises exposing the ground beef to about an equal volume of treatment gas.

14. A method for processing a meat product that includes metmyoglobin and deoxymyoglobin, the method comprising: exposing the meat product to a treatment gas containing carbon monoxide wherein the metmyoglobin and deoxymyoglobin are converted to carboxymyoglobin.

15. The method of claim 14 further comprising obtaining the meat product from one or more of beef, lamb, pork, poultry, and fish.

16. The method of claim 4 wherein exposing the meat product to the treatment gas further comprises exposing the meat product to treatment gas that contains up to about 0.4% carbon monoxide by volume.

17. The method of claim 14 wherein exposing the meat product to the treatment gas further comprises exposing the meat product to treatment gas that contains about 1.0% carbon monoxide by volume.

18. The method of claim 14 wherein exposing the raw meat product includes exposing a volume of the ground beef to a volume of the treatment gas in approximately a 1:1 ratio.

19. The method of claim 14 further comprising packaging and sealing the raw meat product in one or more of a chub or lidstock before exposing the raw meat product to the treatment gas.

20. The method of claim 14 wherein exposing the raw meat product causes substantially all of the metmyoglobin and deoxymyoglobin to convert to carboxymyoglobin.
